(19) United States
(12) Patent Application Publication
(10) Pub. No.: US 2009/0093172 A1
(43) Pub. Date: Apr. 9, 2009

(54) SYSTEMS AND METHODS FOR UTILIZING SINGLE DETECTIVE PIN OF HOST TO SUPPORT PLURALITY OF EXTERNAL APPARATUS

(76) Inventor: Chien-Hua Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/867,011

(22) Filed: Oct. 4, 2007

(51) Int. Cl. H01R 4/18

(52) U.S. Cl. 439/866

(57) ABSTRACT

A system for coupling at least two external apparatus to a detective pint of a host includes: a first connector supporting a first external apparatus and having a first connector pin for transmitting a first signal; a second connector supporting a second external apparatus and having a second connector pin for transmitting a second signal; and an interconnection device for joining the first signal and the second signal into a resultant signal and transmitting the resultant signal to the detective pin of the host.

### BACKGROUND

With the advent of digital technology, many audio-visual media can be instantly displayed on home computers, cell phones, or digital cameras with the use of external devices such as memory cards, for example, PCMCIA (Personal Computer Memory Card International Association) etc. Each such device requires a connector coupled to a host for housing the memory card. Some connectors are only configured for a specific device while other ‘complex’ connectors can support many devices.

When a memory card is inserted into the connector, the host needs to recognize that an external device is inserted so that it can access the stored data and display it. To facilitate this, the host comprises many detective pins, each detective pin connected to a separate connector via a respective connector pin. As complex connectors can support a plurality of external devices they comprise a plurality of connector pins, each connector pin utilized for a different apparatus.

As each supported apparatus requires a respective detective pin, the more apparatus supported by a host, the more detective pins of the host must be reserved. The increasing pin count of the host raises the cost and is inefficient since some of the reserved detective pins are rarely used.

### SUMMARY

It is therefore an objective of the present invention to provide a system for connecting external apparatus to a displaying device while saving the number of required detective pins.

With this in mind, a system for coupling at least two external apparatus to a single detective pin of a host is disclosed. The system comprises: a first connector supporting a first external apparatus and having a first connector pin for transmitting a first signal; a second connector supporting a second external apparatus and having a second connector pin for transmitting a second signal; and an interconnection device, coupled to the first connector pin, the second connector pin and the detective pin of the host, for joining the first signal and the second signal into a resultant signal and transmitting the resultant signal to the detective pin of the host. When the first signal and the second signal have different logic for indicating insertion of the apparatus, the interconnection device comprises a logic gate coupled to the first connector pin for inverting the logic of the first signal.

A system for utilizing a detective pin of a host to support at least two external apparatus according to a second embodiment of the present invention is disclosed. The system comprises: a connector supporting a first external apparatus and a second external apparatus, for transmitting a first signal and a second signal from the first external apparatus and the second external apparatus respectively; and an interconnection device, coupled to the connector and the host, for transmitting the first signal and the second signal in a resultant signal path, wherein the resultant signal path is coupled to the detective pin. The connector has a first connector pin and a second connector pin for transmitting the first signal and the second signal respectively. The interconnection device is coupled to the first connector pin and the second connector pin and joins the first signal and the second signal into the resultant signal path. When the first signal and the second signal have different logic for indicating insertion, the interconnection device comprises a logic gate coupled to the first signal for inverting the logic of the first signal.

A system for utilizing a detective pin of a host to support at least two external apparatus according to a third embodiment of the present invention is disclosed. The system comprises: a connector supporting a first external apparatus and a second external apparatus, for transmitting a first signal and a second signal from the first external apparatus and the second external apparatus respectively; and an interconnection device, coupled to the connector and the host, for transmitting the first signal and the second signal in a resultant signal path, wherein the resultant signal path is coupled to the detective pin. The connector has a single connector pin, the first signal and the second signal are joined into the resultant signal path inside the connector, and the interconnection device is coupled to the single connector pin. When the first signal and the second signal have different logic for indicating insertion, the connector comprises a logic gate coupled to the first signal for inverting the logic of the first signal.

A method according to the first embodiment of the present invention is also disclosed. The method is for determining which apparatus from a plurality of external apparatus supported by a detective pin of a host are inserted, and comprises: performing an apparatus initialization test of an external apparatus supported by the host detective pin; determining if a confirmation signal is received; performing the above two steps for each of the plurality of external apparatus supported by the host detective pin; and utilizing determination results to determine which external apparatus are connected to the host detective pin.

A method according to the second and third embodiments of the present invention is also disclosed. The method is for determining which apparatus from a plurality of external apparatus supported by a host detective pin coupled to a host is inserted, and comprises: performing an apparatus initialization test of a first supported apparatus; and when the apparatus initialization test result is not positive, performing an apparatus initialization test of another supported apparatus until a positive result is obtained.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a system according to a first embodiment of the present invention.

FIG. 2 is a flowchart of a validation method implemented in the system shown in FIG. 1.

FIG. 3 is a diagram of a system according to a second embodiment of the present invention.

FIG. 4 is a diagram of a system according to a third embodiment of the present invention.

FIG. 5 is a flowchart of a validation method implemented in the systems shown in FIG. 3 and FIG. 4.

### DETAILED DESCRIPTION

The following disclosure will refer to three embodiments of the present invention, however, it will be clear from reading the detailed description that the inventive principle is not limited to only being applied to the referenced embodiments.

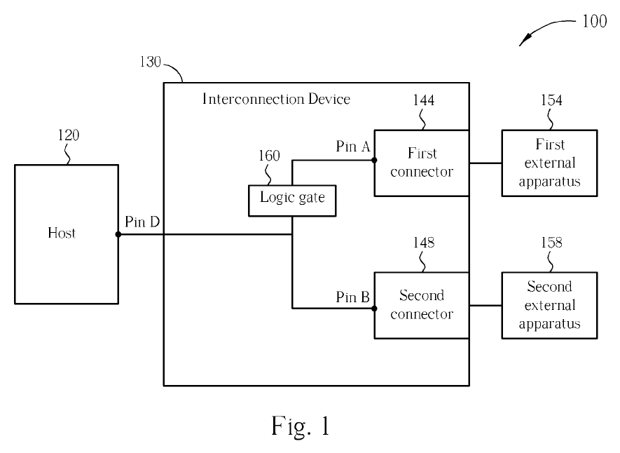

Please refer to FIG. 1. FIG. 1 is a diagram of a system 100 according to a first embodiment of the present invention. The system 100 utilizes a first connector 144 and a second connector 148 to respectively connect a first external apparatus 154 and a second external apparatus 158 to a host 120. Embodiments of the first and second apparatus 154 and 158 comprise a memory card such as MS (memory stick) card, SD (secure digital) card, xD (extreme digital picture) card, CF (compact flash) card, and storage device coupling by an interface such as IDE (integrated drive electronics) or ATA (advance technology attachment). Please note that, although there are only two external apparatus 154 and 158 shown in FIG. 1, this is merely for simplicity of illustration, and the present invention can support more than two types of external apparatus. The first external apparatus 154 and the second external apparatus produce a first signal and a second signal respectively. The first connector 144 has a connector pin represented as Pin A in FIG. 1, and the second connector 148 has a connector pin represented as Pin B. The pins are joined together on the interconnection device 130 and coupled to a single detective pin (Pin D) of the host 120.

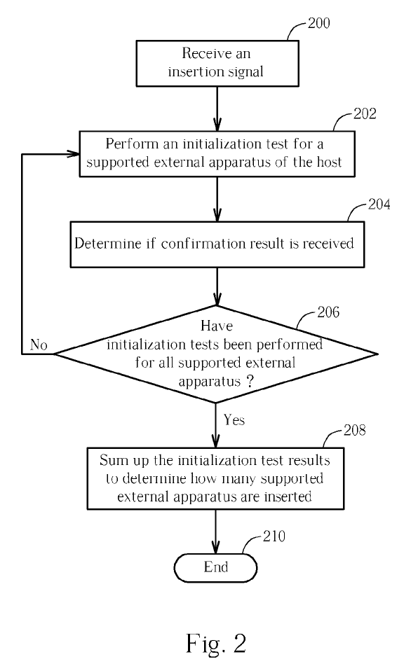

Please refer to FIG. 1 and FIG. 2 together. As Pin D will receive a signal confirming an apparatus is inserted, but cannot distinguish which apparatus is inserted, the host 120 needs a way of determining which and how many apparatus are currently inserted. Advantageously, this can be performed in conjunction with a validation procedure. Initially, the host 120 attempts validation of the supported first external apparatus 154; if the result is a positive result then the host 120 can confirm that the supported first external apparatus 154 is inserted. The host 120 then proceeds with validation of all supported apparatus, and sums up the results to determine which and how many supported external apparatus are currently inserted.

The steps of the method according to FIG. 2 are detailed below.
Step 200: Receive an insertion signal;
Step 202: Perform an initialization test for a supported external apparatus of the host;
Step 204: Determine if confirmation result is received;
Step 206: Have initialization tests been performed for all supported external apparatus? If yes go to Step 208, if no go back to Step 202;
Step 208: Sum up the initialization test results to determine how many supported external apparatus are inserted;
Step 210: End.

As all apparatus utilize a single detective pin (Pin D) of the host 120, all external apparatus have to utilize a same logic to indicate insertion, so that Pin D can confirm each apparatus is inserted. The system 100 utilizes logic gates on the interconnection device 130 to invert the logic for indicating insertion of one or more apparatus. In FIG. 1, the first signal and the second signal are assumed to have opposite logic for indicating insertion, therefore logic gate 160 is implemented on the interconnection device 130. Obviously, the present invention is not limited to a single logic gate, and other configurations of logic gates or systems without such logic gates are also within the scope of the present invention.

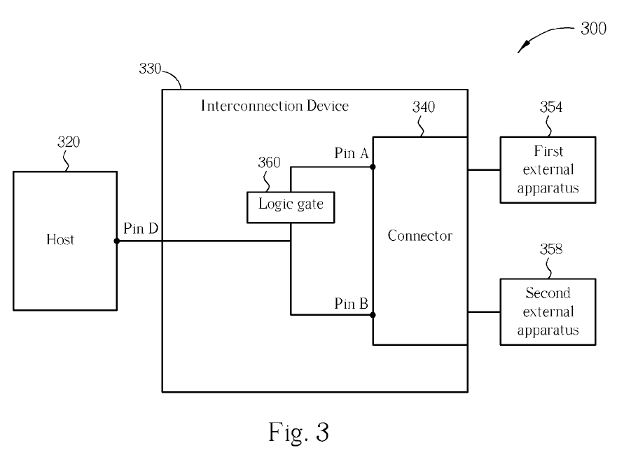

As mentioned above, complex connectors only connect one apparatus at a time to a host. The principle of only utilizing one detective pin for connection can be just as readily applied to complex connectors as to single connectors, however. Please refer to FIG. 3. FIG. 3 is a diagram of a system 300 according to a second embodiment of the present invention. The complex connector 340 shown in FIG. 3 has connector pins Pin A and Pin B, wherein Pin A is for coupling the first external apparatus 354 to the host 320 and Pin B is for coupling the second external apparatus 358 to the host 320. As in the system 100, the first external apparatus 354 produces a first signal, the second external apparatus 358 produces a second signal, and the first and second signals are joined on the interconnection device 330 to form a resultant signal path, which is coupled to the detective pin (Pin D) of the host 320. As before, if the first external apparatus 354 and the second external apparatus 358 utilize a different logic for indicating insertion, the system 300 employs a logic gate 360 on the interconnection device 330 (external to the connector 340) for inverting the logic of the apparatus insertion signal for one of the external apparatus (for example, the first external apparatus 354 in FIG. 3), before it is passed to Pin D.

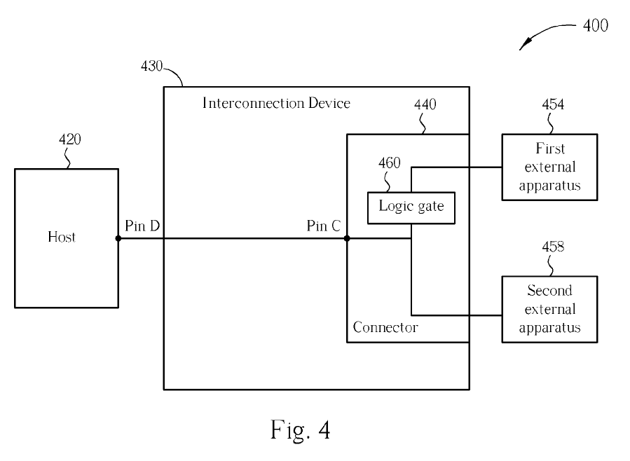

Please refer to FIG. 4. FIG. 4 is a diagram of a system 400 according to a third embodiment of the present invention. The connector 440 shown in FIG. 4 is a complex connector 440 having all connector pins for coupling to external apparatus on the inside of the connector 440, and a single connector pin (Pin C) on the outside. Therefore, if the first signal from the first external apparatus 454 and the second signal from the second external apparatus 458 have different logic for insertion indication, a logic gate 460 is implemented inside the connector 440 for inverting the first signal.

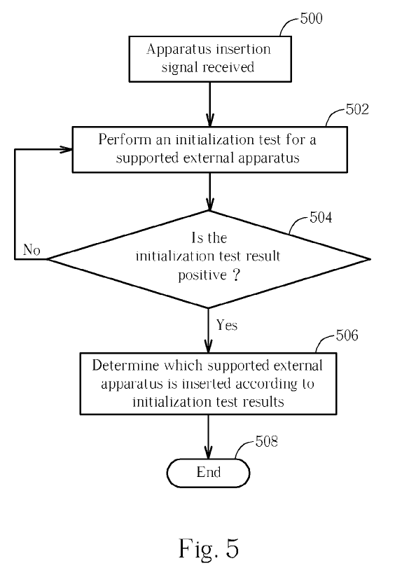

A method for determining which apparatus is currently inserted is detailed below. Please refer to FIG. 5, which is a flowchart detailing the steps of the method. The method corresponds to systems utilizing complex connectors. The method is similar to that detailed in FIG. 2, but as only one external apparatus can be coupled to the host detective pin at a time, when a validation test is positive the method can directly proceed to the polling test for non-supported apparatus. The steps of the method are detailed below.
Step 500: Apparatus insertion signal received;
Step 502: Perform an initialization test for a supported external apparatus;
Step 504: Is the initialization test result positive? If no, go back to Step 502, if yes go to Step 506;
Step 506: Determine which supported external apparatus is inserted according to initialization test results;
Step 508: End.

As can be seen from the above disclosure, embodiments of the present invention provide a system that can significantly save the number of detective pins required of a host for coupling to various types of external apparatus. It can be appreciated by those skilled in the art that further modifications and embodiments are possible, whilst not departing from the spirit of the present invention. Furthermore, the present invention advantageously incorporates a validation procedure into a method for efficiently determining which apparatus are currently inserted.

Those skilled in the art will readily observe that numerous modifications and alterations of the device and method may be made while retaining the teachings of the invention.

What is claimed is:

1. A system for coupling at least two external apparatus to a detective pin of a host, the system comprising:
a first connector supporting a first external apparatus and having a first connector pin for transmitting a first signal;
a second connector supporting a second external apparatus and having a second connector pin for transmitting a second signal; and
an interconnection device, coupled to the first connector pin, the second connector pin and the detective pin of the host, for joining the first signal and the second signal into a resultant signal and transmitting the resultant signal to the detective pin of the host.

2. The system of claim 1, wherein when the first external apparatus and the second external apparatus are coupled to the first connector and the second connector respectively, the logic for indicating insertion is the same for the first signal and the second signal.

3. The system of claim 1, wherein when the first external apparatus and the second external apparatus are coupled to the first connector and the second connector respectively, the logic for indicating insertion for the first signal and the second signal are different logic, and the interconnection device comprises:
a logic gate, coupled to the first connector pin, for inverting the logic for indicating insertion for the first signal.

4. A system for utilizing a detective pin of a host to support at least two external apparatus, the system comprising:
a connector supporting a first external apparatus and a second external apparatus, for transmitting a first signal and a second signal from the first external apparatus and the second external apparatus respectively; and
an interconnection device, coupled to the connector and the host, for joining a path of the first signal and a path of the second signal into a resultant signal path, wherein the resultant signal path is coupled to the detective pin.

5. The system of claim 4, wherein the connector has a first connector pin and a second connector pin, the first connector pin is for transmitting the first signal and the second connector pin is for transmitting the second signal, and the interconnection device is coupled to the first connector pin and the second connector pin and joins the first signal path and the second signal path into the resultant signal path.

6. The system of claim 5, wherein the logic for indicating insertion for the first signal is different from the second signal and the interconnection device comprises:
a logic gate, coupled to the first connector pin, for inverting the logic for indicating insertion for the first signal.

7. The system of claim 4, wherein the connector has a single connector pin, the first signal path and the second signal path are joined into the resultant signal path inside the connector, and the interconnection device is coupled to the single connector pin.

8. The system of claim 7, wherein the first signal has a different logic for indicating insertion from the second signal and the connector comprises:
a logic gate, coupled to the first external apparatus, for inverting the logic of the first signal.

9. A method for determining which apparatus from a plurality of external apparatus supported by a detective pin of a host are inserted, the method comprising:
performing an apparatus initialization test of an external apparatus supported by the host detective pin;
determining if a confirmation signal is received;
performing the above two steps for each of the plurality of external apparatus supported by the host detective pin; and
utilizing determination results to determine which external apparatus are connected to the host detective pin.

10. A method for determining which apparatus from a plurality of external apparatus supported by a host detective pin coupled to a host is inserted, the method comprising:
performing an apparatus initialization test of a first supported apparatus; and
when the apparatus initialization test result is not positive, performing an apparatus initialization test of another supported apparatus until a positive result is obtained.
